(19) United States
(12) Patent Application Publication
(10) Pub. No.: US 2003/0061419 A1
(43) Pub. Date: Mar. 27, 2003

(54) Control block for telephone

(76) Inventors: Vinod Nair Gopikuttan Nair, Singapore (SG); Amit Sadashiv Shaligram, Singapore (SG); Martin Erdmann, Munich (DE)

Correspondence Address: Siemens Corporation, Intellectual Property Department, 186 Wood Avenue South, Iselin, NJ, 08830, US

(21) Appl. No.: 09/964,206

(22) Filed: Sep. 26, 2001

(51) Int. Cl. G06F 13/12

(52) U.S. Cl. 710/62

(57) ABSTRACT

A communication device has a microcontroller for high-speed data handling. A terminal-specific function unit separated from the microcontroller performs all control functions for the user interface devices, preferably keypad scanning, LCD control, and LED control. The function of the circuit block is preferably hard-wired. The circuit block connects to the microcontroller via the microcontroller bus. The microcontroller is freed from user interface control functions and is concentrated on data handling.

### BACKGROUND OF THE INVENTION

The invention relates to a circuit arrangement for a communication device that has a user interface and a data interface and is equipped with a microcontroller. The circuit arrangement may be incorporated in a communication device having devices for the user interface and said circuit arrangement.

A terminal for a communication system has various devices for the human user interface. The communication device receives and outputs or displays voice and imaging data. For interoperability, the communication device has a user interface for various input and output functions. For example, an LCD (Liquid Crystal Display) device is provided to display alphanumeric and graphical data to indicate status information to the user and display static or moving images which are received through the communication channel. At least one of a set of LEDs (Light Emitting Diode) is provided to signal the status of the terminal or the communication system, e.g. on/off information referring to switchable settings or busy/idle information of communication channels. A keypad is provided for the user to input alphanumerical data to be transmitted or to control the terminal.

In conventional terminals, a microcontroller is handling the data stream that is received or is to be transmitted via the communication channel. As voice or image data is concerned, the amount of data to be processed by the microcontroller is considerably large and needs to be processed in real time. The same microcontroller that handles the data to be communicated through the communication channel is further programmed to control the user interface of the terminal. For example, the microcontroller provides the status settings of the LCD display, controls the LEDs, and performs the keypad scanning. The microcontroller reserves registers and memory space for the status settings of the user interface and for the buffering of the scanning of the keypad, respectively. In addition to the handling of the communication data, the microcontroller is also loaded with the handling of the user interface. As a result, the handling of the user interface may interfere with the microcontroller's workload for handling the data from the communication channel.

### SUMMARY OF THE INVENTION

The present invention seeks to provide a circuit arrangement for a communication device where the microcontroller is freed from the control of the user interface.

In accordance with the invention, this object is solved by a circuit arrangement for a communication device having a user interface and a data interface, comprising a microcontroller connected to said data interface which is designed to communicate with at least one high data rate channel; a circuit block different from said microcontroller having control lines connected to said user interface to control the status of said user interface; a bus interface, wherein the circuit block is connected to said microcontroller via said bus interface.

It is another object of the invention to provide a communication device incorporating the circuit arrangement.

The circuit arrangement according to the invention concentrates the user interface specific control functions in a circuit block which is different from said microcontroller. The circuit block realizes the specific functions of the user interface in a hard-wired fashion rather than a software- and microcontroller-based solution. As a consequence, the microcontroller is freed from inputs initiated by the user interface devices. The microcontroller is now dedicated to handle the high data rate communication rather than blocked with monitoring of the user interface.

The circuit block different from said microcontroller can be arranged as an on-board, separated integrated circuit. The circuit block can also be monolithically integrated on the same integrated circuit as the microcontroller. For the communication between the circuit block and the microcontroller, the microcontroller bus is used. The circuit block has control lines that are to be connected to the devices of the user interface. First, any of the control lines can be connected to the LCD display in order to control brightness, dark/white level, contrast etc. of the LCD screen. The control lines are preferably outputs only that forward the status settings to the LCD display. Second, a control line may be connected to an LED display device, e.g. a light-emitting diode, to control the on/off status of the LED in response to a to be signalled status of the terminal or the communication system. Third, any of the control lines can be designed to control the status of the keypad. The above-mentioned control lines are outputs only.

The control lines can further be the scanning lines for the keypad. Each key of the keypad is arranged at the intersection of two control lines. A scanning algorithm periodically scans the keypad to determine which one of the keys is currently pressed. The control lines are bi-directional and function as inputs and outputs to the circuit block.

The circuit block comprises control registers that memorize any settings of the user interface, e.g. brightness and/or contrast of the display, keypad settings, etc. The settings in the control registers are the basis for the control signals that are communicated over the control lines. The control registers are preset and updated via data words that are exchanged through the microcontroller bus.

The circuit block preferably comprises buffers to receive signals from keypad scanning.

The data transfer within the circuit block is governed by a logic control block whereto the control registers, the key scan buffers and all input and output control lines are connected. Further, an interrupt line provided with interrupt signals from the logic control block is input to the microprocessor. Any human interaction via the user interface devices generates an interrupt to the microcontroller and is handled by the microcontroller's interrupt control routines and is responded to appropriately with the pre-determined significance of the type of interrupt. The microcontroller has the dedicated interfaces for the transfer of data that represents voice or image information. Said interfaces are not connected to the circuit block which is dedicated to input and output user interface control information.

In accordance with the invention, a communication device comprises an LCD display device, an LED display device and a keypad device as well as the microcontroller and the circuit block according to the invention, all those elements connected together to function as a communication terminal. Such communication end terminal may be an intelligent multimedia telephone device which is connected to a telephone switch.

### BRIEF DESCRIPTION OF THE DRAWINGS

FIG. 1 shows an embodiment of the invention.

### PREFERRED EMBODIMENTS OF THE INVENTION

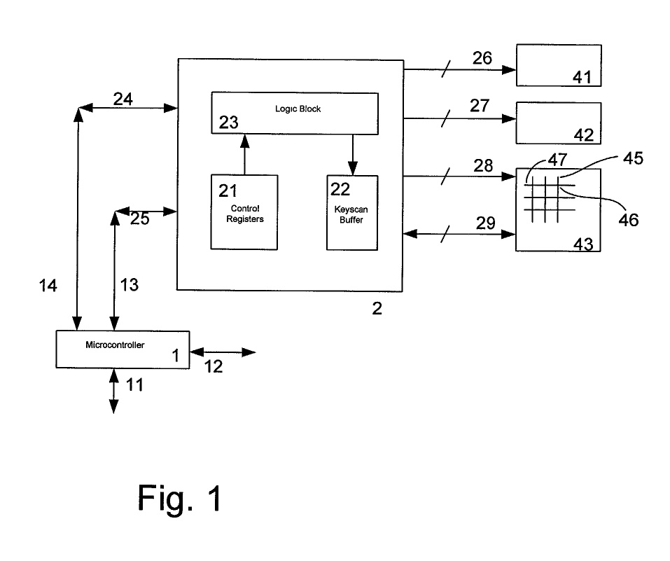

FIG. 1 shows a multi-media terminal in accordance with one embodiment of the invention. As shown, a microcontroller 1 is provided to control the overall performance of the terminal and is especially designed to cope with high data rate communication. The microcontroller has an interface 11 to receive data from an external data source. Preferably, the interface is a USB (Universal Serial Bus) interface as it is currently in use in computer technology. Via the USB interface, various kinds of data can be input to the terminal. The microcontroller further includes an interface 12 connected to the switching host of a PABX system. The interface is often a propriety interface. In the embodiment, the interface transmits data according to an IOM (ISDN-oriented modular) propriety interface defined by Siemens. The microcontroller runs software routines to handle the data transfer via the interfaces 11 and 12. The interfaces 11 and 12 may carry any kinds of data, especially voice or images. The interface 12 includes the information that is transferred through the switching host over a communication channel of a communication network. The microcontroller receives or outputs the data, for example, to a terminal-owned screen or loudspeaker or microphone. The microcontroller has a microcontroller bus interface 13 to transfer data and control signals to other devices. Further, the microcontroller has an input 14 for an interrupt signal. In response to an interrupt, the microcontroller stops the currently running program according to a pre-defined priority and responses to the interrupt.

Further provided is a circuit block 2 which is different and separated from the microcontroller 1. The circuit block 2 can be realized as a stand-alone, separately integrated circuit. Alternatively, the circuit block 2 can be integrated together with the microcontroller 1 on a single integrated circuit. In addition, this circuit can include additional or all integratable hardware features of a multi-media telephone. The circuit block 2 has all necessary hardware in order to control any user interface devices. The user interface devices are an LCD display 41, at least one, preferably a bank of LEDs 42, and a keypad 43. The circuit block 2 is responsible for controlling all settings and statuses of the user interface devices 41, 42, and 43. The circuit block 2 preferably comprises hard-wired logic that performs any conceivable control for the user interface devices 41, 42, and 43, as is explained later.

The circuit block 2 is connected via LCD control lines 26 to the LCD display 41. The control lines 26 are uni-directional so that information is only to be transferred from the circuit block 2 to the LCD device 41. The LCD control lines 26 transmit signals, e.g. for brightness, contrast, etc. of the LCD display. The LEDs 42 are operated via LED control lines 27 from the circuit block 2. The LED control lines transmit at least on/off information for individual LEDs. The keypad 43 has keys, e.g. the key 46, that are arranged at the intersection of scanning lines 45, 47. First, the keypad has status information which is transferred from the circuit block 2 to the keypad 43 via respective control lines 28. Key scan lines 29 connect to the keypad 23 in order to scan the key arrangement of the keypad to determine whether a particular key is currently being pressed. A signal is output to at least one of the scan lines and the response from other scan lines is monitored. The response signal depends on whether a particular key is pressed or not. The control lines 26, 27, and 28 are uni-directional. The key scan lines 29 are bi-directional so that signals can be output from the circuit block 2 to the keypad and returned to the circuit block 2.

The circuit block 2 has a set of control registers 21. The register bank 21 memorizes all the settings for the external devices 41, 42, 43. Those settings can be input via the microcontroller 1. The control lines 26, 27, 28, and 29 carry signals in response to the control registers 21. The control registers 21 are updated from the microcontroller 1 by data that is transmitted via the microcontroller bus. A set of buffers 22 is provided to intermediately store the signals from the key scan lines 29.

The function of the control block 2 is implemented in a hard-wired, that is without the use of software by logic gates only. The logic control block 23 supervises all data communication from and to the microcontroller 1 and from and to the user interface devices 41, 42, and 43. Further, the logic block 23 controls any internal data flow. It reads the control registers 21 and it sets the key scan buffers 22 during a keypad scanning operation. All external control lines 26, 27, 28, and 29 are connected to the logic control block 23. Further, the circuit block 2 has a microcontroller bus interface 25 and an interrupt line 24 which are also connected to the logic control block 23.

As an advantage of the invention, the microcontroller 1 is freed from any low data rate, although time-consuming, control workload for the user interface devices. The microcontroller 1 is now dedicated to the handling of the workload coming from the high data rate interfaces 11 and 12. The control functions for the user interface devices are managed externally to the microcontroller and are implemented in dedicated hardware in the circuit control block 2. As a consequence, the communication performance of the terminal and the quality of the handling of the communication data is improved. Since the microcontroller can be dedicated to data handling and system level control functions only, a cheaper on-board microcontroller can be used.

What is claimed is:

1. A circuit arrangement for a communication device having a user interface and a data interface, comprising:
a microcontroller connected to said data interface which is designed to communicate with at least one high data rate channel;
a circuit block different from said microcontroller having control lines connected to said user interface to control the status of said user interface;
a bus interface, wherein the circuit block is connected to said microcontroller via said bus interface.

2. The circuit arrangement according to claim 1, wherein the circuit block comprises at least one of a group of control lines, said group comprising:
a first one of control lines providing a signal to control the status of an LCD display device;
a second one of control lines providing a signal to control an LED display device;
a third one of control lines providing a signal to control the status of a keypad device; and
a fourth one of control lines to provide and receive signals to scan each one of the keys of said keypad device.

3. The circuit arrangement according to claim 1, wherein said circuit block comprises a set of control registers that are designed to contain a setting information for at least one device of the group comprising a LCD display device, a LED display device, and a keypad device.

4. The circuit arrangement according to claim 3, wherein said control registers receive data from said microcontroller via said bus interface.

5. The circuit arrangement according to claim 1, wherein said circuit block comprises a set of buffers to receive signals from a set of scanning lines connected to said keypad device.

6. The circuit arrangement according to claim 1, wherein said circuit block comprises a set of control registers that are designed to contain a setting information for at least on e device of the group comprising a LCD display device, a LED display device and a keypad device, and wherein said circuit block comprises a set of buffers to receive signals from a set of scanning lines which are connected to said keypad device.

7. The circuit arrangement according to claim 6, wherein said circuit block comprises a logic control block controlling the data exchange between said control lines, said bus interface and said set of control registers and said set of buffers.

8. The circuit arrangement according to claim 7, wherein an interrupt line is provided which is coupled to said logic control block of said circuit block and to an interrupt input of said microcontroller.

9. The circuit arrangement according to any of claims 1 to 8, wherein said microcontroller has an interface for the transfer of data, said data representing voice or image information, said interface being not connected to said circuit block.

10. A communication device, comprising:
a user interface and a data interface, said user interface comprising an LCD display device, an LED display device, and a keypad device;
a microcontroller connected to said data interface which is designed to communicate with at least one high data rate channel;
a circuit block different from said microcontroller having control lines connected to said user interface to control the status of said user interface;
a bus interface, wherein the circuit block is connected to said microcontroller via said bus interface.

11. The communication device according to claim 10, wherein the circuit block comprises at least one of a group of control lines, said group comprising:
a first one of control lines providing a signal to control the status of an LCD display device;
a second one of control lines providing a signal to control an LED display device;
a third one of control lines providing a signal to control the status of a keypad device; and
a fourth one of control lines to provide and receive signals to scan each one of the keys of said keypad device.

12. The communication device according to claim 10, wherein said circuit block comprises a set of control registers that are designed to contain a setting information for at least one device of the group comprising said LCD display device, said LED display device, and said keypad device.

13. The communication device according to claim 12, wherein said control registers receive data from said microcontroller via said bus interface.

14. The communication device according to claim 10, wherein said circuit block comprises a set of buffers to receive signals from a set of scanning lines connected to said keypad device.

15. The communication device according to claim 10, wherein said circuit block comprises a set of control registers that are designed to contain a setting information for at least one device of the group comprising said LCD display device, said LED display device and said keypad device, and wherein said circuit block comprises a set of buffers to receive signals from a set of scanning lines which are connected to said keypad device.

16. The communication device according to claim 15, wherein said circuit block comprises a logic control block controlling the data exchange between said control lines, said bus interface and said set of control registers and said set of buffers.

17. The communication device according to claim 16, wherein an interrupt line is provided which is coupled to said logic control block of said circuit block and to an interrupt input of said microcontroller.

18. The communication device according to any of claims 10 to 17, wherein said microcontroller has an interface for the transfer of data, said data representing voice or image information, said interface being not connected to said circuit block.
